(19) United States
(12) Patent Application Publication
(10) Pub. No.: US 2019/0371126 A1
(43) Pub. Date: Dec. 5, 2019

(54) MULTI-SCREEN GAMING WITH CROSS-GAME TUMBLING TRIGGER

(71) Applicant: Aristocrat Technologies Australia Pty Limited, North Ryde (AU)

(72) Inventor: T. Grant Bolling, JR., Reno, NV (US)

(21) Appl. No.: 16/000,585

(22) Filed: Jun. 5, 2018

(51) Int. Cl. G07F 17/32

(52) U.S. Cl. CPC G07F 17/3267; G07F 17/3244; G07F 17/3213

(57) ABSTRACT

An electronic gaming machine that awards additional opportunities to extend game play. The electronic gaming machine displays a number of games having independent game outcomes. When one of the game outcomes includes a winning combination of symbols, symbols at display positions that form the winning combination of symbols and symbols at corresponding or matching display positions of other game outcomes are replaced with symbols. The game outcomes with the replaced symbols are re-evaluated for winning combinations.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player (RTP=return to player) over the course of many plays or instances of the game. The RTP and randomness of the RNG are critical to ensuring the fairness of the games and are, therefore, highly regulated. Upon initiation of play, the RNG randomly determines a game outcome and symbols are then selected which correspond to that outcome. Notably, some games may include an element of skill on the part of the player and are, therefore, not entirely random.

Many game experiences are also specifically designed to take advantage of a given game and to provide a special game feel. For many players, the special game feel of a game is an essential element for delivering an entertaining and exciting experience, and, in turn, increased revenue for the operator. For example, when the game has a winning outcome, the game provides an award, and the game terminates. With the termination of the game, the special game feel also terminates or wears off. Thus, this limits the ability of game developers to design games that can sustain or extend the special game feel experiences.

### SUMMARY

An embodiment provides a system and method of extending game play on an electronic gaming machine. The electronic gaming machine displays a number of games having game outcomes. When one of the game outcomes includes a winning combination of symbols, symbols at display positions that form the winning combination of symbols and symbols at matching display positions at one or more other game outcomes are replaced with symbols. The game outcomes with the replaced symbols are re-evaluated for winning combinations.

Specifically, an electronic gaming machine has a memory that stores a set of symbols, and a display that displays a plurality of game instances at a plurality of sets of display positions. Each display position of a game instance has a corresponding or matching display position at each of the other instances. When a game instance has a winning combination of symbols, the display replaces visually a) the winning combination of symbols with a plurality of symbols, and b) any symbols at a corresponding or matching plurality of display positions of each of the other game instances.

### BRIEF DESCRIPTION OF THE DRAWINGS

FIG. 1 is an exemplary diagram showing several EGMs networked with various gaming related servers.

FIG. 2 is a block diagram showing various functional elements of an exemplary EGM.

FIGS. 3A-3M illustrate a series of screenshots of a multi-screen tumbler game.

FIG. 4 illustrates a flowchart of a multi-game tumbling process.

### DETAILED DESCRIPTION

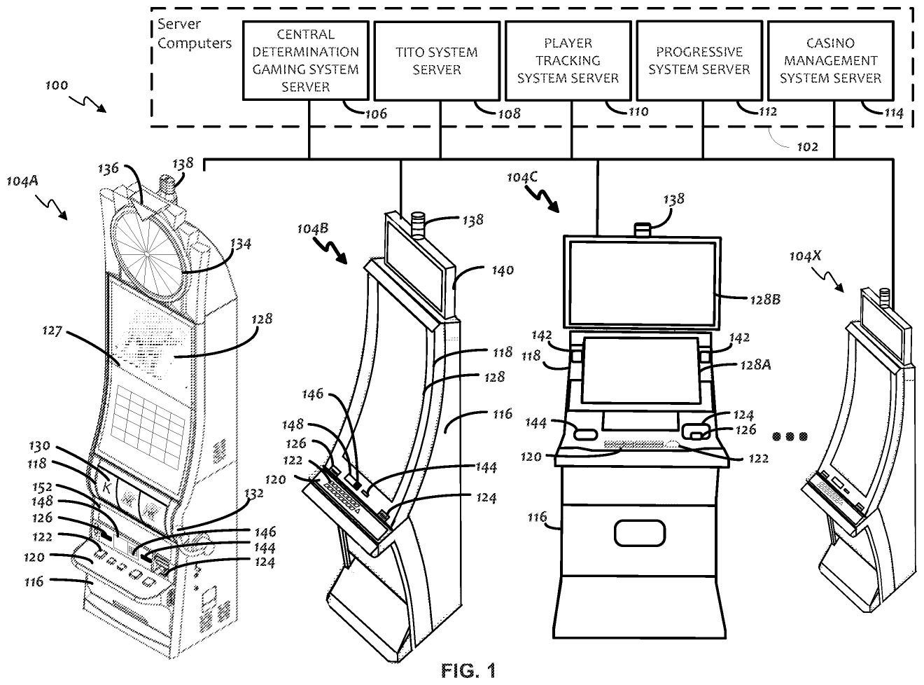

FIG. 1 illustrates several different models of EGMs which may be networked to various gaming related servers. The present invention can be configured to work as a system 100 in a gaming environment including one or more server computers 102 (e.g., slot servers of a casino) that are in communication, via a communications network, with one or more gaming devices 104A-104X (EGMs, slots, video poker, bingo machines, etc.). The gaming devices 104A-104X may alternatively be portable and/or remote gaming devices such as, but not limited to, a smart phone, a tablet, a laptop, or a game console.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, the present invention may, in one or more embodiments, be practiced on a stand-alone gaming device such as gaming device 104A, gaming device 104B or any of the other gaming devices 104C-104X. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over a network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door 118 which provides access to the interior of the cabinet. Gaming device 104A typically includes a button area or button deck 120 accessible by a player that is configured with input switches or buttons 122, an access channel for a bill validator 124, and/or an access channel for a ticket printer 126.

In FIG. 1, gaming device 104A is shown as a RELM XL™ model gaming device manufactured by Aristocrat® Technologies, Inc. As shown, gaming device 104A is a reel machine having a gaming display area 127 comprising a number (typically 3 or 5) of mechanical reels 130 with various symbols displayed on them. The reels 130 are independently spun and stopped to show a set of symbols within the gaming display area 127 which may be used to determine an outcome to the game.

In many configurations, the gaming machine 104A may have a main display 128 (e.g., video display monitor) mounted to, or above, the gaming display area 127. The main display 128 can be of variety type, e.g., high-resolution LCD, plasma, LED, or OLED panel which may be flat or curved as shown, a cathode ray tube, or other conventional electronically controlled video monitor. The main display 128 may one or more various orientations (i.e., landscape or portrait), aspect ratios and resolutions.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A.

In some embodiments, a player tracking card reader 144, a transceiver for wireless communication with a player's smartphone, a keypad 146, and/or an illuminated display 148 for reading, receiving, entering, and/or displaying player tracking information is provided in EGM 104A. In such embodiments, a game controller (not shown in FIG. 1) within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of a base or a primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

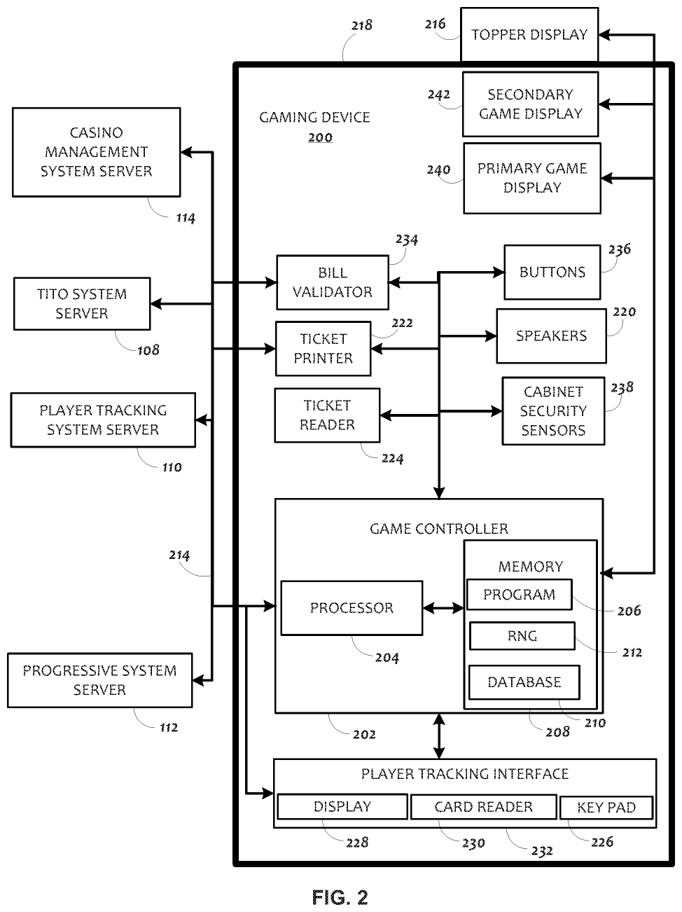

Many or all the above described components can be controlled by circuitry (e.g., a gaming controller) housed inside the main cabinet 116 of the gaming device 104A, the details of which are shown in FIG. 2.

Note that not all gaming devices suitable for implementing embodiments of the present invention necessarily include top wheels, top boxes, information panels, cashless ticket systems, and/or player tracking systems. Further, some suitable gaming devices have only a single game display that includes only a mechanical set of reels and/or a video display, while others are designed for bar counters or table tops and have displays that face upwards.

An alternative example gaming device 104B illustrated in FIG. 1 is the Arc™ model gaming device manufactured by Aristocrat® Technologies, Inc. Note that, where possible, reference numerals identifying similar features of the gaming device 104A embodiment are also identified in the gaming device 104B embodiment using the same reference numbers. Gaming device 104B does not include physical reels and instead shows game play functions on main display 128. An optional topper screen 140 may be used as a secondary or additional game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main door 118 which opens to provide access to the interior of the gaming device 104B. The main or service door 118 is typically used by service personnel to refill the ticket-out printer 126 and collect bills and tickets inserted into the bill validator 124. The door 118 may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the landscape-style main display 128A may have a curvature radius from top to bottom, or alternatively from side to side. In some embodiments, main display 128A is a flat panel display. Main display 128A is typically used for primary game play while secondary display 128B is typically used for bonus game play, to show game features or attraction activities while the game is not in play or any other information or media desired by the game designer or operator.

Many different types of games, including mechanical slot games, video slot games, video poker, video black jack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3 gaming environments, etc.

FIG. 2 is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases 210 may be provided for use by the program 206. A random number generator (RNG) 212 that can be implemented in hardware and/or software is typically used to generate random numbers that are used in the operation of game play to ensure that game play outcomes are random and meet regulations for a game of chance.

Alternatively, a game instance (i.e. a play or round of the game) may be generated on a remote gaming device such as a central determination gaming system server 106 (not shown in FIG. 2 but shown in FIG. 1). The game instance is communicated to gaming device 200 via the network 214 and then displayed on gaming device 200. Gaming device 200 may execute game software, such as, but not limited to, video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include random access memory (RAM), read only memory (ROM) or another form of storage media that stores instructions for execution by the processor 204.

The gaming device 200 may include a topper display 216 or another form of a top box (e.g., a topper wheel, a topper screen, etc.) which sits above main cabinet 218. The gaming cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking display 228 for displaying information (e.g., an illuminated or video display), and a card reader 230 for receiving data and/or communicating information to and from media or a device such as a smart phone enabling player tracking. Ticket printer 222 may be used to print tickets for a TITO system server 108. The gaming device 200 may further include a bill validator 234, buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices 200, such as gaming devices 104A-104X, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a coin acceptor (not shown) or bill validator 234 to establish a credit balance on the gaming machine. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views the game outcome on the game displays 240, 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

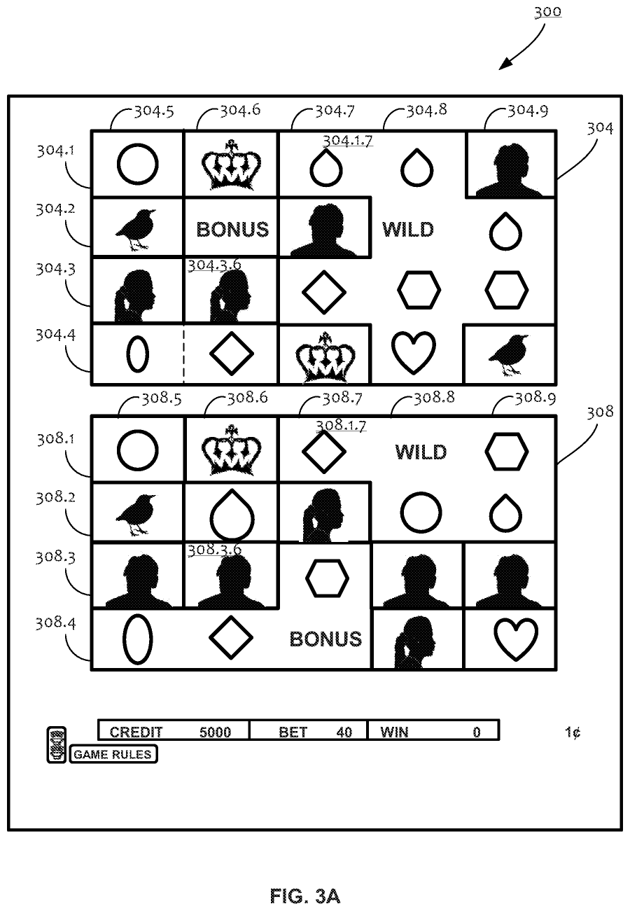

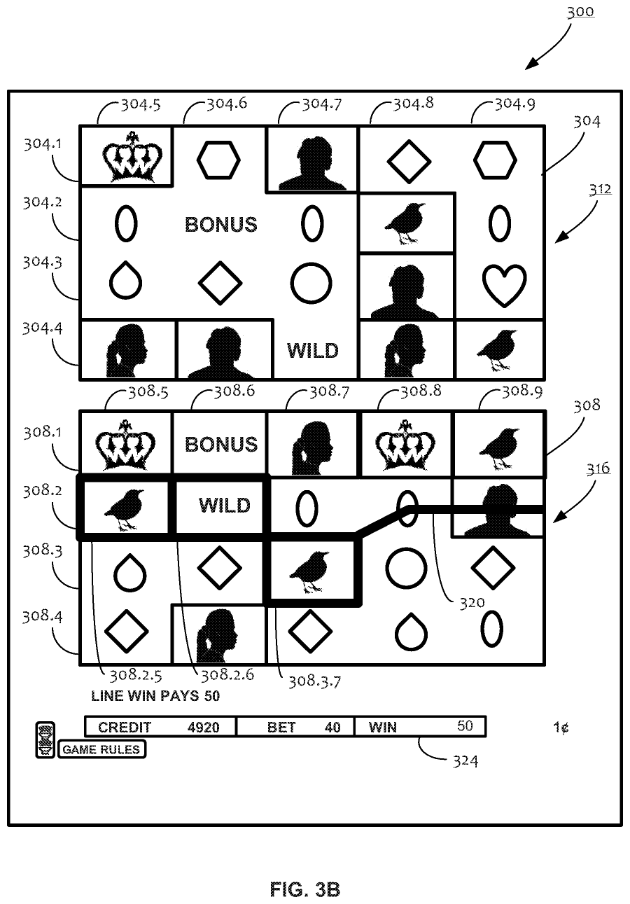

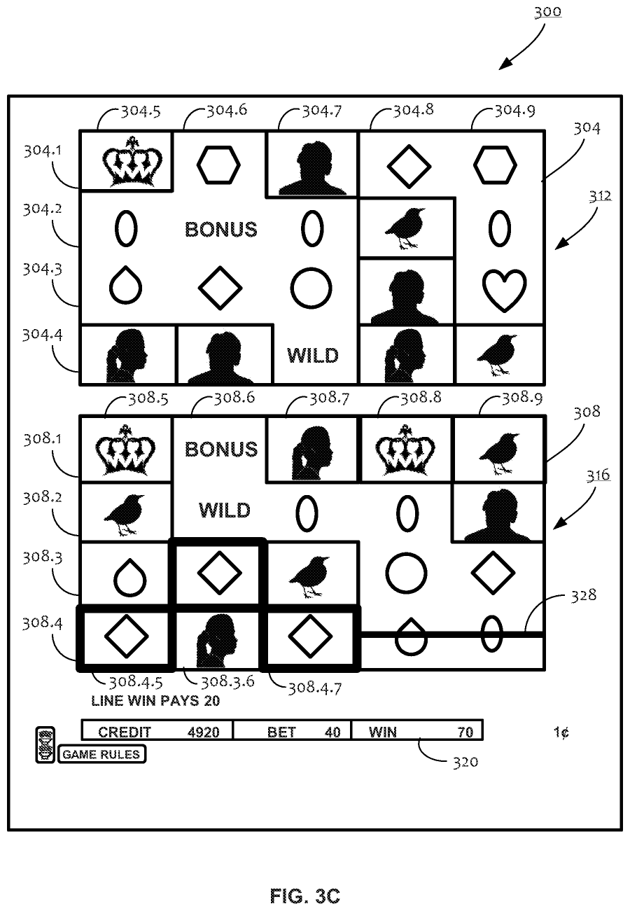

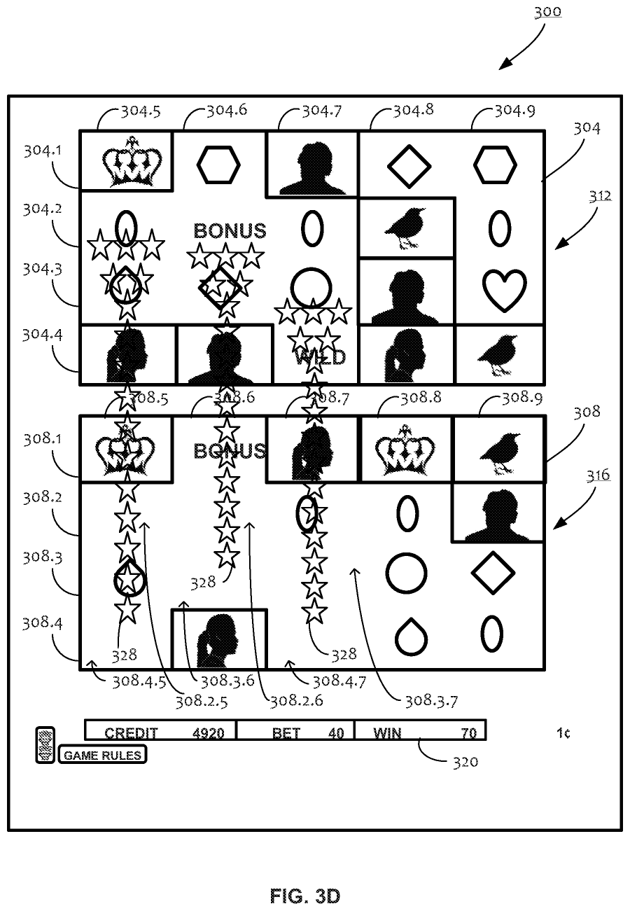

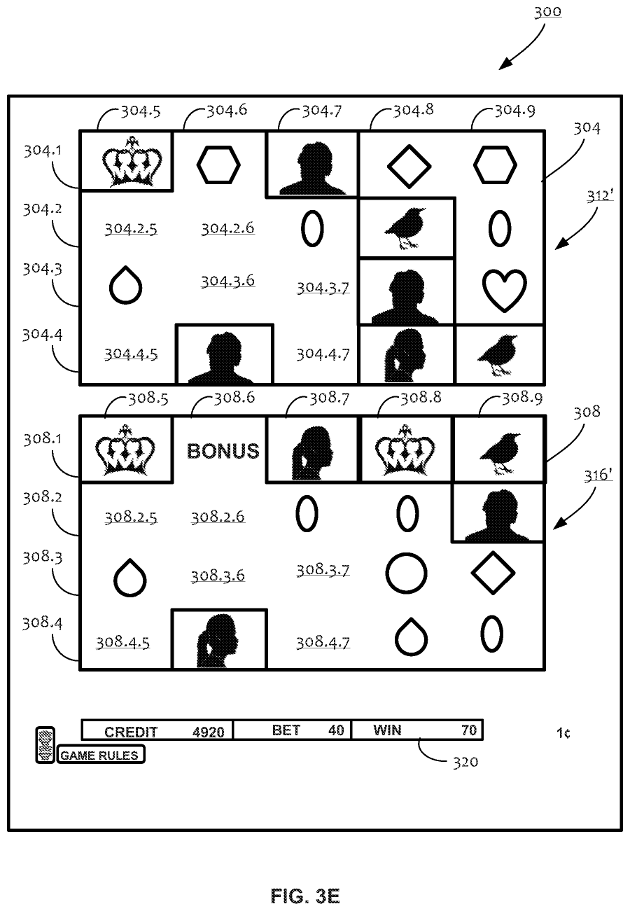

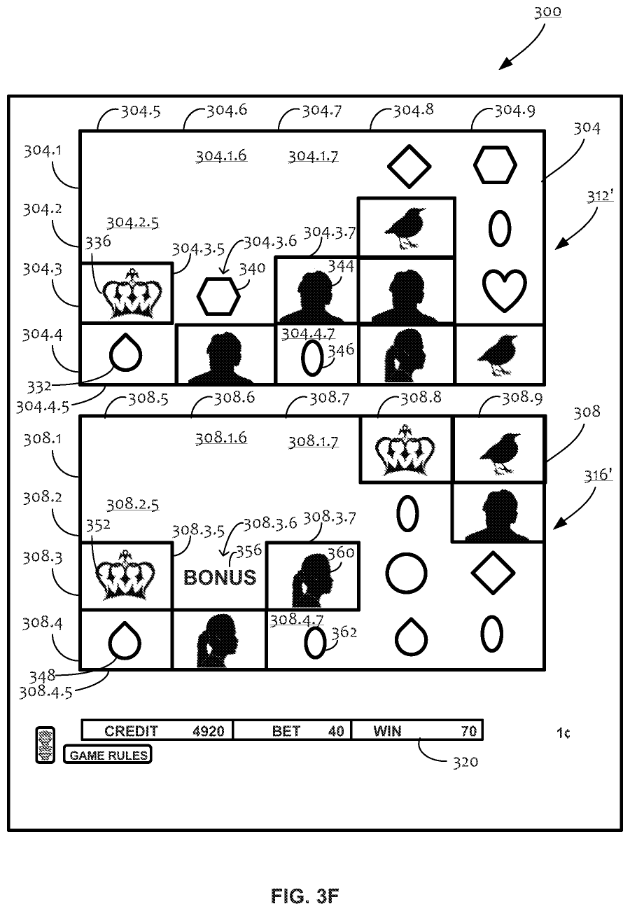

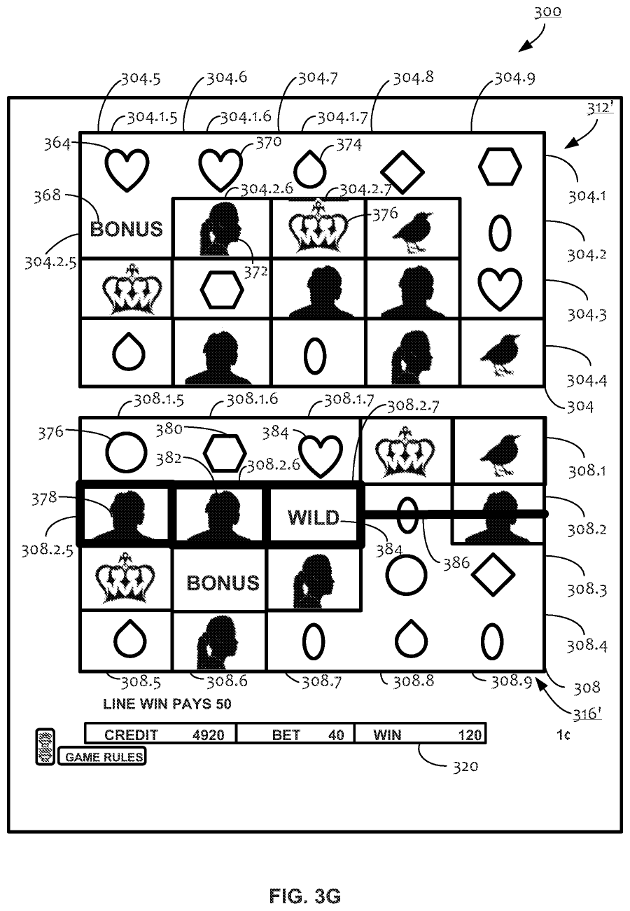

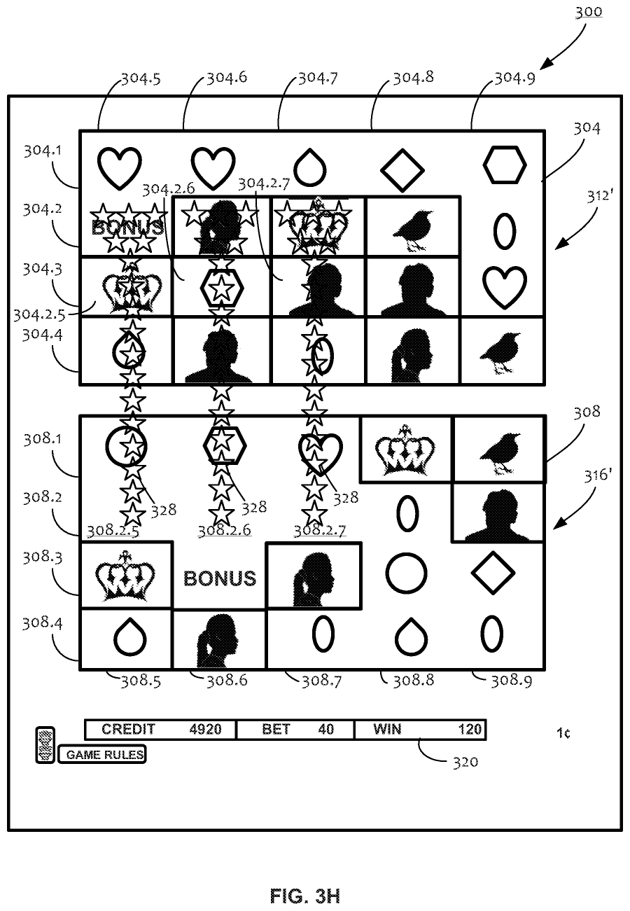

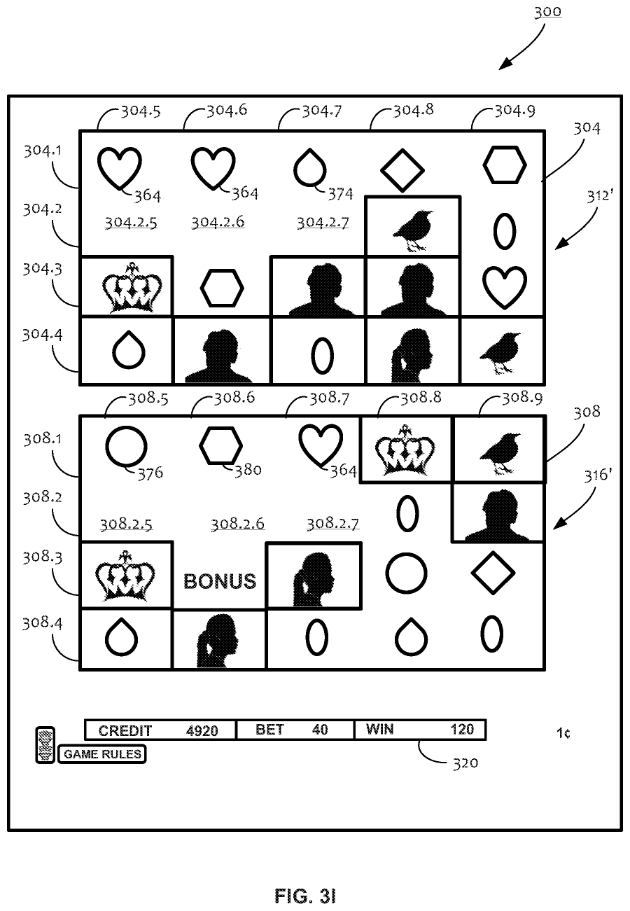

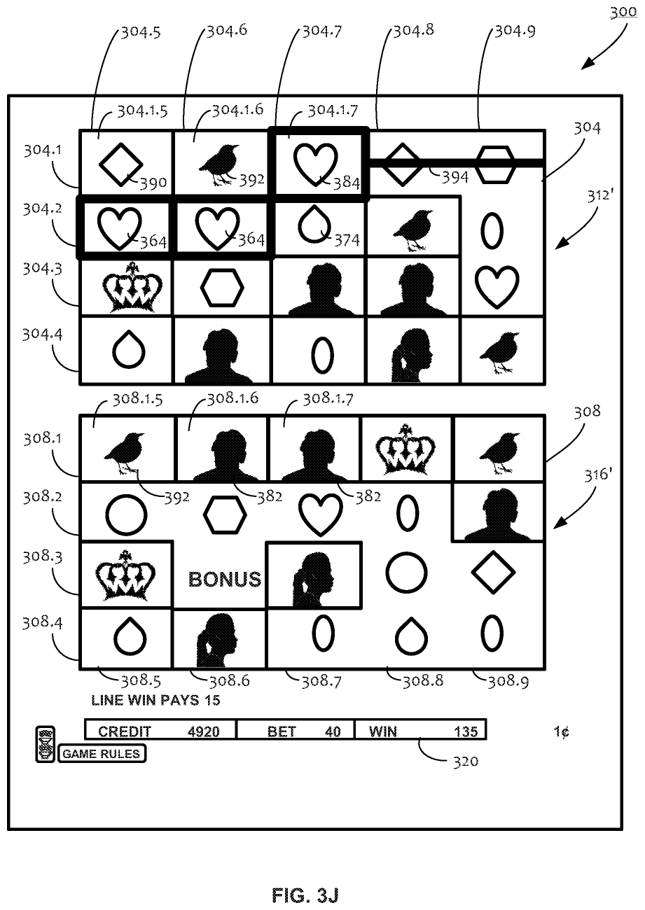

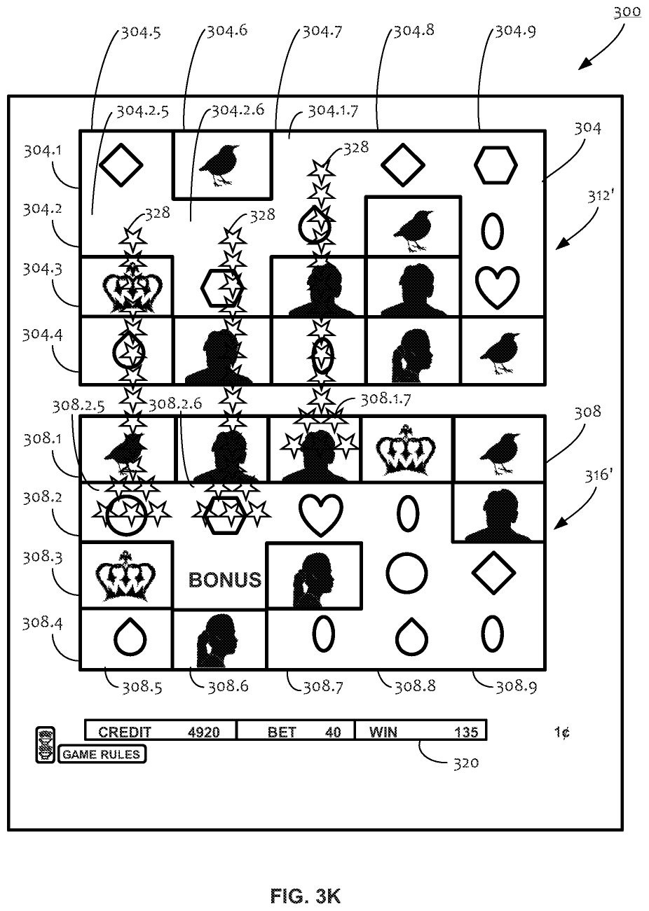

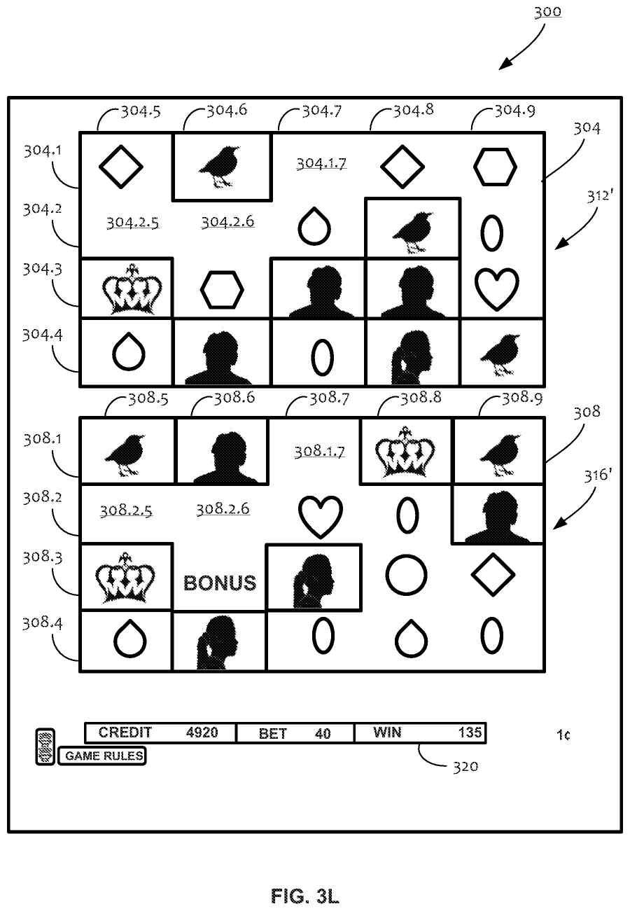

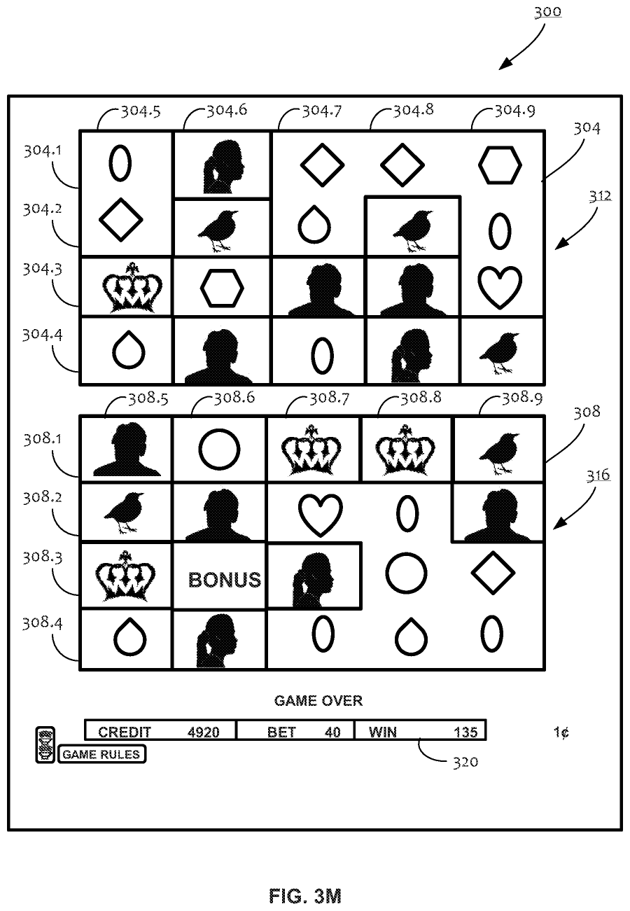

FIGS. 3A-3M illustrate a series of screenshots of a multi-screen tumbler game 300. As shown, the multi-screen tumbler game 300 shows a first game 304 and a second game 308. Each of the first game 304 and the second game 308 may include respective winning outcomes, or respective winning combinations of symbols. In the illustrated embodiment, the multi-screen tumbler game 300 only shows two different games. However, the multi-screen tumbler game 300 may include a larger number of multi-screen games, for example, six games, or eight games in other embodiments. Although not shown, a player may be able to interactively select a number of games to be played from a list of available games.

Referring back to FIG. 3A, each of the first game 304 and the second game 308 has a plurality of symbols displayed at a plurality of respective display positions. As shown, the first game 304 has twenty display positions arranged in a 4×5 matrix represented by four rows 304.1, 304.2, 304.3, and 304.4, and five columns 304.5, 304.6, 304.7, 304.8, and 304.9. Similarly, the second game 308 has twenty display positions arranged in a 4×5 matrix represented by four rows 308.1, 308.2, 308.3, and 308.4, and five columns 308.5, 308.6, 308.7, 308.8, and 308.9. As shown, each of the first game 304 and the second game 308 has twenty display positions. In other cases, the first game 304 and the second game 308 may have different number of display positions. Additionally, each display position of the first game 304 is represented by a corresponding row and a corresponding column, and has a corresponding or matching display position of the second game 308, also represented by a corresponding row and a corresponding column. For example, display position 304.1.7 (representing row 304.1 and column 304.7, and showing a droplet symbol) of the first game 304 has a corresponding display position 308.1.7 (representing row 308.1 and column 308.7, and showing a diamond symbol) of the second game instance 308. Similarly, display position 304.3.6 (representing row 304.3 and column 304.6, and showing a pony tail lady symbol) of the first game 304 has a corresponding display position 308.3.6 (representing row 308.3 and column 308.6, and showing a man symbol) of the second game 308.

Referring to FIG. 3B, the first game 304 and the second game 308 generate a first game instance 312 and a second game instance 316. The second game instance 316 includes a first winning pay line 320 having display position 308.2.5 (showing a bird symbol), display position 308.2.6 (showing a wild symbol, which substitutes for any other symbol), and display position 308.3.7 (showing a bird symbol). Thus, the first winning pay line 320 shows a winning combination of three bird symbols (two bird symbols and a wild symbol), and pays fifty (50) credits as shown in win credit meter 324. Referring to FIG. 3C, the second game instance 316 additionally includes a second winning pay line 328 having display position 308.4.5 (showing a diamond symbol), display position 308.3.6 (showing a diamond symbol), and display position 308.4.7 (showing a diamond symbol) that pays twenty (20) credits. The win credit meter 320 then reflects a total of seventy (70) credits (50 credits+20 credits).

As a result of the second game instance 316 having winning combinations of symbols via first winning pay line 320 and second winning pay line 328, symbols in the winning combinations of symbols are removed. FIG. 3D shows that the bird symbol displayed in display position 308.2.5, the wild symbol displayed in display position 308.2.6, and the bird symbol displayed display position 308.3.7 in first winning pay line 320, and the diamond symbols displayed in display position 308.4.5, display position 308.3.6, and display position 308.4.7 in second winning pay line 328, are removed. Simultaneously or subsequently, symbols displayed in display positions 304.2.5, 304.2.6, and 304.3.7 (corresponding to display positions 308.2.5, 308.2.6, and 308.3.7, respectively) of the first game instance 312 are marked for removal. Similarly, symbols displayed in display positions 304.4.5, 304.3.6, and 304.4.7 (corresponding to display positions 308.4.5, 308.3.6, and 308.4.7, respectively) of the first game instance 312 are also marked for removal. As shown, an animation 328 in the form of shooting stars is displayed originating from display positions 308.2.5, 308.2.6, 308.3.7, 308.4.5, 308.3.6, and 308.4.7 and landing at the corresponding display positions including display positions 304.2.5, 304.2.6, 304.3.7, 304.4.5, 304.3.6, and 304.4.7, respectively. In other embodiments, other animations may be used. For example, animation in the form of fireworks may shoot from display positions 308.2.5, 308.2.6, 308.3.7, 308.4.5, 308.3.6, and 308.4.7 and land at matching display positions including display positions 304.2.5, 304.2.6, 304.3.7, 304.4.5, 304.3.6, and 304.4.7, respectively.

Removing the winning combination of symbols of the first plurality of display positions, and the symbols displayed in the corresponding display positions of the second plurality of display positions results in a plurality of blank or empty display positions in an alternate first game instance 312′ and in an alternate second game instance 316′. FIG. 3E shows the alternate first game instance 312′ and the alternate second game instance 316′ after symbols have been removed from display positions 308.2.5, 308.2.6, 308.3.7, 308.4.5, 308.3.6, and 308.4.7 in the first game instance 312, and display positions 304.2.5, 304.2.6, 304.3.7, 304.4.5, 304.3.6, and 304.4.7 in the second game instance 316. As such, display positions 304.2.5, 304.2.6, 304.3.7, 304.4.5, 304.3.6, 304.4.7, 308.2.5, 308.2.6, 308.3.7, 308.4.5, 308.3.6, and 308.4.7 are blank or empty display positions after the removal.

Simultaneously or subsequently to the removal, the display positions 304.2.5, 304.2.6, 304.3.7, 304.4.5, 304.3.6, 304.4.7, 308.2.5, 308.2.6, 308.3.7, 308.4.5, 308.3.6, and 308.4.7 are replaced with symbols. For example, some or all of the empty display positions may be replaced with a plurality of symbols that are initially adjacent the empty display positions. In such cases, the plurality of symbols that are initially adjacent the empty display positions are depicted to move or tumble into the empty display positions. For example, as shown in FIG. 3F, in the alternate first game instance 312′, a droplet symbol 332 has been moved or tumbles visually from display position 304.3.5 into display position 304.4.5. Similarly, a crown symbol 336 has been moved or tumbles visually from display position 304.2.5 into display position 304.3.5. In column 304.6, a hexagon symbol 340 has been moved or tumbles visually two display positions from display position 304.1.6 into display position 304.3.6. Similarly, a man symbol 344 and an oval symbol 346 have been moved or tumble visually two display positions from display positions 304.1.7 and 304.2.7 into display positions 304.3.7 and 304.4.7, respectively.

Referring back to FIG. 3F, in the alternate second game instance 316′, a second droplet symbol 348 has been moved or tumbles visually from display position 308.3.5 into display position 308.4.5. Similarly, a second crown symbol 352 has been moved or tumbles visually from display position 308.2.5 into display position 308.3.5. In column 308.6, a BONUS symbol 356 has been moved or tumbles visually two display positions from display position 308.1.6 into display position 308.3.6. Similarly, a pony tail lady symbol 360 and a second oval symbol 362 have been moved or tumble visually two display positions from display positions 308.1.7 and 308.2.7 into display positions 308.3.7 and 308.4.7, respectively.

Simultaneously or subsequently to the move of symbols as described above, the display positions 304.1.5, 304.2.5, 304.1.6, 304.2.6, 304.1.7, 304.2.7, 308.1.5, 308.2.5, 308.1.6, 308.2.6, 308.1.7, and 308.2.7, which are now empty display positions, are replaced with symbols. For example, some or all of the empty display positions may be replaced with a plurality of symbols that are randomly selected. For another example where each of the columns 304.5, 304.6, 304.7, 304.8, 304.9, 308.5, 308.6, 308.7, 308.8, and 308.9 represents a portion of a continuous reel strip of symbols, some or all of the empty display positions may be replaced with a plurality of symbols that are previously not shown and adjacent the recently removed symbols.

Referring to FIG. 3G, which illustrates that display positions 304.1.5, 304.2.5, 304.1.6, 304.2.6, 304.1.7, 304.2.7, 308.1.5, 308.2.5, 308.1.6, 308.2.6, 308.1.7, and 308.2.7, are filled with randomly selected symbols, or symbols on a corresponding reel strip. As shown in column 304.5, a heart symbol 364 and a BONUS symbol 368 have visually tumbled into display positions 304.1.5 and 304.2.5, respectively. As shown in column 304.6, a heart symbol 370 and a pony tail lady symbol 372 have visually tumbled into display positions 304.1.6 and 304.2.6, respectively. As shown in column 304.7, a droplet symbol 374 and a crown symbol 376 have also visually tumbled into display positions 304.1.7 and 304.2.7, respectively. Similarly, as shown in column 308.5 in the alternate second game instance 316′, a circle symbol 376 and a man symbol 378 have visually tumbled into display positions 308.1.5 and 308.2.5, respectively. As shown in column 308.6, a hexagon symbol 380 and a man symbol 322 have visually tumbled into display positions 308.1.6 and 308.2.6, respectively. As shown in column 308.7, a heart symbol 384 and a wild symbol 386 have also visually tumbled into display positions 308.1.7 and 308.2.7, respectively.

Both the alternate first game instance 312′ and the alternate second game instance 316′ are completely filled with a plurality of symbols at the first plurality of display positions and the second plurality of display positions, respectively. The alternate first game instance 312′ and the alternate second game instance 316′ are re-evaluated for winning combinations of symbols. As shown in FIG. 3G, The alternate second game instance 316′ includes a third winning pay line 386 having display positions 308.2.5, 308.2.6, and 308.3.7, having a winning combination of two man symbols 378, 382, and the wild symbol 384. As shown, the winning combination of symbols with respect to the third pay line 386 pays fifty (50) credits. The win credit meter 320 then reflects a total of one hundred and twenty (120) credits (70 credits+50 credits).

FIG. 3H shows that two man symbols 378, 382, and the wild symbol 384 that form the third winning pay line 386 having display positions 308.2.5, 308.2.6, and 308.2.7 are removed. Simultaneously or subsequently, symbols displayed in display positions 304.2.5, 304.2.6, and 304.2.7 (matching display positions 308.2.5, 308.2.6, and 308.2.7, respectively) of the first game instance 312′ are marked for removal. As shown, animation 328 is displayed originating from display positions 308.2.5, 308.2.6, 308.2.7, and landing at the corresponding or matching display positions including display positions 304.2.5, 304.2.6, and 304.2.7, respectively. FIG. 3I shows the alternate first game instance 312′ and the alternate second game instance 316′ after symbols have been removed from display positions 308.2.5, 308.2.6, and 308.2.7 in the first game instance 312′, and display positions 304.2.5, 304.2.6, and 304.2.7 in the second game instance 316′. As such, display positions 304.2.5, 304.2.6, 304.2.7, 308.2.5, 308.2.6, and 308.2.7 are blank or empty display positions after the removal. Simultaneously or subsequently to the removal, the display positions 304.2.5, 304.2.6, 304.2.7, 308.2.5, 308.2.6, and 308.2.7 are replaced with symbols. For example, as shown in FIG. 3J, in the alternate first game instance 312′, two heart symbols 364 and a droplet symbol 374 have been moved or tumble visually from display positions 304.1.5, 304.1.6, and 304.1.7 into display positions 304.2.5, 304.2.6, and 304.2.7, respectively. Similarly, in the alternate second game instance 316′, circle symbol 376, hexagon symbol 380, and heart symbol 364 have been moved or tumble visually from display positions 308.1.5, 308.1.6, and 308.1.7 into display positions 308.2.5, 308.2.6, and 308.2.7, respectively.

Simultaneously or subsequently, also as shown in FIG. 3J, display positions 304.1.5, 304.1.6, 304.1.7, 308.1.5, 308.1.6, and 308.1.7 are filled with randomly selected symbols, or adjacent symbols on a corresponding reel strip. Specifically, a diamond symbol 390, a bird symbol 392, and a heart symbol 364 fill display positions 304.1.5, 304.1.6, and 304.1.7 in the alternate first game instance 312′, respectively, and a bird symbol 392, and two man symbols 382 fill display positions 308.1.5, 308.1.6, and 308.1.7 in the alternate second game instance 316′, respectively. However, FIG. 3J shows that three heart symbols 364 form a fourth winning pay line 394, which pays fifteen (15) credits. The win credit meter 320 then reflects a total of one hundred and thirty five (135) credits (120 credits+15 credits).

As discussed above, when a winning combination occurs in a game instance, corresponding symbols in matching display positions are also removed. In the example shown in FIG. 3J, the fourth winning pay line 394 occurs in the alternate first game instance 312′. As such, corresponding symbols in matching display positions are also removed from the alternate second game instance 316′. FIG. 3K illustrates that the three heart symbols 364 that form the fourth winning pay line 394 are removed from the alternate first game instance 312′. Simultaneously or subsequently, symbols in corresponding or matching display positions including display positions 308.2.5, 308.2.6, and 308.1.7 are also removed via animation 328. FIG. 3L shows empty display positions 304.2.5, 304.2.6, 304.1.7 in the alternate first game instance 312′, and empty display positions 308.2.5, 308.2.6, 308.1.7 in the alternate second game instance 316′. FIG. 3M illustrates that empty display positions 304.2.5, 304.2.6, 304.1.7 in the alternate first game instance 312′, and empty display positions 308.2.5, 308.2.6, 308.1.7 in the alternate second game instance 316′ are filled. However, the alternate first game instance 312′ and the alternate second game instance 316′ do not include any winning outcome, which terminates the multi-screen tumbler game 300.

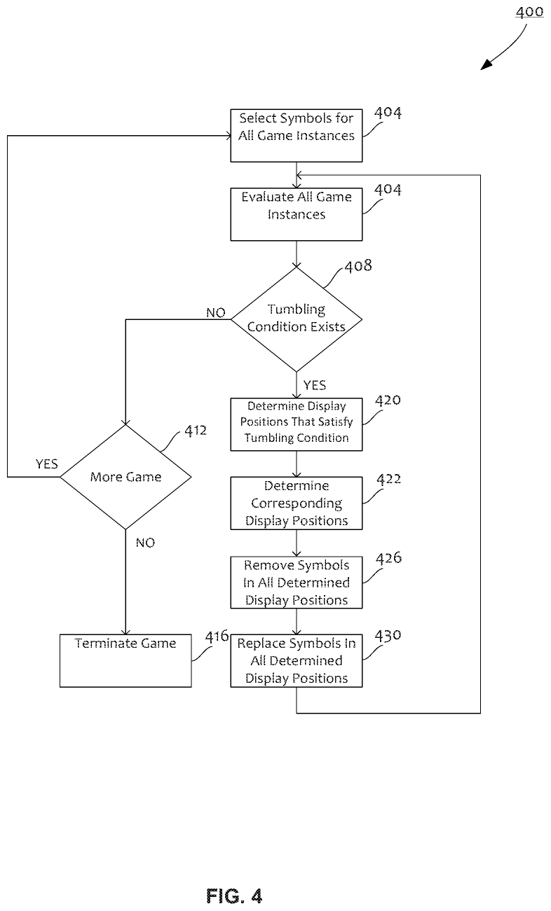

FIG. 4 illustrates a flowchart of a multi-game tumbling process 400. At block 402, the multi-game tumbling process 400 selects symbols for display at the display positions of a plurality of games, thus forming a respective game instance at each of the games. (See, e.g., the first game instance 312 and second game instance of FIG. 3A). At block 404, the symbols selected for all the game instances are evaluated. For example, the game controller 202 of FIG. 2 determines if the symbols selected in the game instances include any predetermined special symbol or a winning combination of symbols, as discussed above with respect to FIGS. 3A-3M. At block 408, the multi-game tumbling process 400 determines if a cross-game tumbling condition exists in any of the game instances. An example cross-game tumbling condition may include a winning combination of symbols in one of the game instances, as discussed with respect to block 404. Another example cross-game tumbling condition may include a predetermined special symbol being displayed.

If the multi-game tumbling process 400 determines that a cross-game tumbling condition does not exist in any of the game instances, the multi-game tumbling process 400 determines at block 412 if more games are to be played. If the multi-game tumbling process 400 determines at block 412 that no more games are to be played, the multi-game tumbling process 400 terminates at block 416.

Referring back to FIG. 4, if the multi-game tumbling process 400 determines at block 408 that one or more cross-game tumbling conditions exist in one of the game instances, the multi-game tumbling process 400 proceeds to block 420. At block 420, the multi-game tumbling process 400 determines a plurality of display positions of symbols that satisfy the cross-game tumbling condition. Simultaneously or concurrently, at block 422, the multi-game tumbling process 400 determines a plurality of display positions corresponding to or matching the plurality of display positions of symbols that satisfy the cross-game tumbling condition, as determined in block 420. For example, if the multi-game tumbling process 400 determines at block 420 that symbols displayed in display positions 304.1.5, 304.1.6, and 304.1.7 of the alternate first game instance 312′ form a winning combination or satisfy the cross-game tumbling condition, the multi-game tumbling process 400 designates display positions 308.1.5, 308.1.6, and 308.1.7 as corresponding or matching display positions in the alternate second game instance 316′, as described above with respect to FIG. 3J. At block 426, the multi-game tumbling process 400 removes the symbols that satisfy the cross-game tumbling condition and the symbols at the corresponding display positions, as described above with respect to FIGS. 3A-3M. At block 430, the multi-game tumbling process 400 replaces symbols displayed at the plurality of corresponding display positions with other symbols, as described above. The multi-game tumbling process 400 then proceeds back to block 404 to re-evaluate the symbols displayed.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

1. A method of extending game play of a wagering game on an electronic gaming machine having a display device, a game controller, and a credit input mechanism, the credit input mechanism being configured to receive a physical item representing a monetary value for establishing a credit balance that is increasable and decreasable based on wagering activity, the method comprising the steps of:
controlling, via the game controller, the display device to provide a plurality of display areas, each display area having a plurality of display positions, wherein each display position in one display area corresponds to a display position in display areas other than the one display area;
initiating a game in response to a wager, the game comprising the steps of:
(a) adjusting the credit balance in accordance with the wager;
(b) displaying, via the game controller, symbols selected from a set of symbols at each of the display positions in the plurality of display areas;
(c) determining, via the game controller, if the symbols displayed in one display area of the plurality of display areas include one or more winning symbol combinations;
(d) in response to each determined winning symbol combination in the one display area, displaying an animation for each display position of the respective winning symbol combination, the animation marking the respective display position in the one display area and each corresponding display position in the plurality of display areas different from the one display area for removal, and displaying a path between the respective display position and the each corresponding display position;
(e) creating one or more blank display positions in the one display area by removing, via the game controller, any symbols that form a winning symbol combination from the one display area;
(f) for any symbol removed from the one display area, creating corresponding blank display positions in the plurality of display areas different from the one display area by removing, via the game controller, symbols at the corresponding display positions in all display areas different from the one display area;
(g) after creating the one or more blank display positions in the one display area and the corresponding blank display positions in the plurality of display areas different from the one display area, displaying, via the game controller, symbols in the one or more blank display positions in the one display area and the corresponding blank display positions in the plurality of display areas different from the one display area;
(h) repeating steps (c) through (g) until an end condition occurs; and
(i) adjusting the credit balance in accordance with any winning outcomes.

2. The method of claim 1, wherein the end condition occurs when no winning combinations are displayed in any of the display areas.

3. The method of claim 1, wherein the end condition comprises repeating steps (c) through (g) a predetermined number of times.

4. The method of claim 1, wherein displaying symbols in the one or more blank display positions in the one display area comprises moving symbols adjacent the one or more blank display positions into the one or more blank display positions.

5. The method of claim 4, wherein displaying symbols in the corresponding blank display positions in the plurality of display areas different from the one display area further comprises moving symbols from positions adjacent the corresponding blank display positions into the corresponding blank display positions.

6. The method of claim 4, further comprising randomly selecting symbols to fill the one or more blank display positions.

7. The method of claim 4, further comprising evaluating symbols displayed in the one display area for a winning outcome.

8. The method of claim 1, further comprising selecting the symbols in the one display area independently of the symbols in the plurality of display areas different from the one display area.

9. (canceled)

10. An electronic method of extending game play on a gaming machine, the gaming machine includes a credit input mechanism configured to receive a physical item representing a monetary value for establishing a credit balance, the credit balance being increasable and decreasable based on a wagering activity, a credit meter configured to monitor the credit balance, a display device configured to display a first plurality of display positions and a second plurality of display positions, each display position of the first plurality of display positions having a corresponding display position at the second plurality of display positions, a memory storing a set of symbols, and a game controller, the method comprising:
displaying a first game instance and a second game instance at the first plurality of display positions and the second plurality of display positions, respectively;
evaluating, via the game controller, the first game instance for a winning combination of symbols displayed at a first group of display positions in the first plurality of display positions; and
in response to the first game instance having the winning combination of symbols in the first group of display positions:
displaying, for each display position of the first group of display positions, one or more objects originating from the respective display position and landing at a corresponding display position in a second group of display positions of the second set of display positions that corresponds to the first group of display positions;
replacing the winning combination of symbols in the first group of display positions with a first plurality of symbols; and
replacing a second plurality of symbols displayed at the second group of display positions with a third plurality of symbols.

11. The electronic method of claim 10, further comprising:
moving the first plurality of symbols from display positions adjacent the first group of display positions into the first group of display positions; and
moving the third plurality of symbols from display positions adjacent the second group of display positions into the second group of display positions.

12. The electronic method of claim 10, further comprising randomly selecting the first plurality of symbols and the third plurality of symbols from the set of symbols to respectively move into the first group of display positions and the second group of display positions.

13. The electronic method of claim 10, further comprising, after replacing the winning combination of symbols, evaluating symbols displayed in the first plurality of display positions for another winning combination of symbols.

14. The electronic method of claim 10, further comprising:
selecting a fourth plurality of symbols for display positions of the first game instance that remain empty after replacing the winning combination of symbols; and
independently selecting a fifth plurality of symbols for display positions of the second game instance that remain empty after replacing the second plurality of symbols.

15. (canceled)

16. An electronic gaming machine comprising:
a credit input mechanism configured to receive a physical item representing a monetary value for establishing a credit balance, the credit balance being increasable and decreasable based on a wagering activity;
a credit meter configured to monitor the credit balance;
a memory storing a set of symbols;
a display device configured to display a first game instance at a first plurality of display positions and a second game instance at a second plurality of display positions, each display position of the first plurality of display positions having a corresponding display position at the second plurality of display positions; and
a game controller executing instructions store in the memory, wherein execution of the instructions causes the game controller to at least:
evaluate the first game instance for a winning combination of symbols displayed at a first group of display positions of the first plurality of display positions; and
in response to the first game instance having the winning combination of symbols displayed at the first group of display positions, control the display device to:
display, for a first display position of the first group of display positions, one or more objects originating from the first display position and landing at a corresponding second display position in a second group of display positions;
replace the winning combination of symbols in the first group of display positions with a first plurality of symbols; and
replace a second plurality of symbols displayed at the second group of display positions with a third plurality of symbols.

17. The electronic gaming machine of claim 16, wherein execution of the instructions further causes the game controller to control the display device to:
visually move the first plurality of symbols from display positions adjacent the first group of display positions into the first group of display positions, and
visually move the third plurality of symbols from display positions adjacent the second group of display positions into the second group of display positions.

18. The electronic gaming machine of claim 16, wherein execution of the instructions further causes the game controller to:
randomly select the first plurality of symbols and the third plurality of symbols from the set of symbols to respectively move into the first group of display positions and the second group of display positions.

19. The electronic gaming machine of claim 16, wherein execution of the instructions further causes the game controller to evaluate symbols displayed in the second plurality of display positions for another winning combination of symbols after replacing the second plurality of symbols with the third plurality of symbols.

20. The electronic gaming machine of claim 16, wherein execution of the instructions further causes the game controller to:
select a fourth plurality of symbols for display positions of the first game instance that remain empty after replacing the winning combination of symbols, and
independently select a fifth plurality of symbols for display positions of the second game instance that remain empty after replacing the second plurality of symbols.

21. (canceled)

22. The method of claim 1, wherein the animation, for each display position of the respective winning symbol combination, depicts one or more objects originating from the respective display position and landing at each corresponding display position in the plurality of display areas different from the one display area.

23. The electronic method of claim 10, wherein displaying one or more objects comprising displaying fireworks originating from the respective display position and landing at the corresponding display position in the second group of display positions.

24. The electronic gaming machine of claim 16, wherein display of the one or more objects comprises displaying shooting stars originating from the first display and landing at the corresponding second display position in the second group of display positions.
